(19) United States
(12) Patent Application Publication
(10) Pub. No.: US 2026/0094344 A1
(43) Pub. Date: Apr. 2, 2026

(54) DYNAMIC RAY RETURN FOR MID-TRAVERSAL AND POST-TRAVERSAL SHADING

(71) Applicant: Advanced Micro Devices, Inc., Santa Clara, CA (US)

(72) Inventors: Michael John Livesley, Milton Keynes (GB); Sean Keely, Santa Clara, CA (US); J. Stephen Junkins, Santa Clara, CA (US)

(73) Assignee: Advanced Micro Devices, Inc., Santa Clara, CA (US)

(21) Appl. No.: 18/899,265

(22) Filed: Sep. 27, 2024

(51) Int. Cl. G06T 15/06; G06T 1/20; G06T 15/80

(52) U.S. Cl. CPC G06T 15/06; G06T 1/20; G06T 15/80

(57) ABSTRACT

Techniques herein involve operations for reducing divergence for ray tracing. In ray tracing on parallel hardware, rays are processed in “wavefronts” which include multiple threads that execute in lockstep. High divergence can occur in ray tracing as ray processing can have very outcomes. Techniques presented herein reduce divergence by swapping rays between wavefronts at intermediate processing points. The swapping groups more coherent rays together, thereby reducing divergence and increasing efficiency.

### BACKGROUND

In image synthesis, ray tracing is utilized to find a nearest intersection of a given ray with a scene where light propagation is simulated.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates operation of a shader core and BVH traversal engine for performing ray tracing operations, according to an example;

FIG. 6 illustrates divergent control flow of shader execution for the shader core, according to an example;

FIG. 7 illustrates operations for reorganizing rays among different wavefronts, according to an example;

FIGS. 8A and 8B illustrate different configurations for writing out such state from a source wavefront, according to examples; and

FIG. 9 is a flow diagram of a method for performing ray tracing operations, according to an example.

### DETAILED DESCRIPTION

Ray tracing is a rendering technique whereby rays are cast into a scene and pixels of a render target are colored based on which objects the rays intersect. To speed such operations up, a ray tracing system typically builds an acceleration structure such as a bounding volume hierarchy (“BVH”). Such a structure has a hierarchy of levels, where each level can include bounding volumes that bound the geometry of lower levels.

Ray tracing can be implemented in a highly parallel architecture in which multiple work-items execute in parallel (within a logical construct referred to as a “wavefront”), and each work-item is assigned a particular ray. Each ray traverses through the BVH to identify shading work to perform for the ray in order to determine color and/or other attributes for a pixel corresponding to the ray. Then, a shader core performs the shading work. Rays may alternate between traversing through the BVH and performing shading work in this manner until processing for the ray is complete.

As stated above, parallel processing of these rays can become inefficient in the event that the type of work being performed by different rays differs. This condition is referred to as “divergence,” and results in the different types of work being performed serially rather than in parallel. To avoid this, techniques are disclosed herein for swapping rays between wavefronts in order to reduce divergence. Such techniques generally involve tracking which rays are ready to be returned to the shader core for execution of shader operations, where such rays can originate from different wavefronts. These tracked rays are swapped between wavefronts in a manner that reduces divergence, by grouping rays that are coherent (i.e., that execute the same type of work) together. These techniques also increase occupancy of wavefronts that are running mid or post traversal shading. Even if the lanes that are packed together into wavefronts are not completely coherent, having more work to do in any given wavefront improves overall performance by reducing the overhead associated with having multiple wavefronts execute different control flow paths.

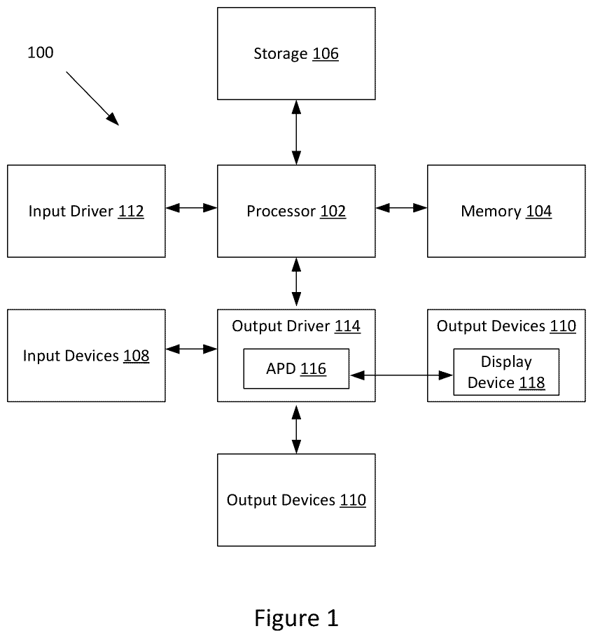

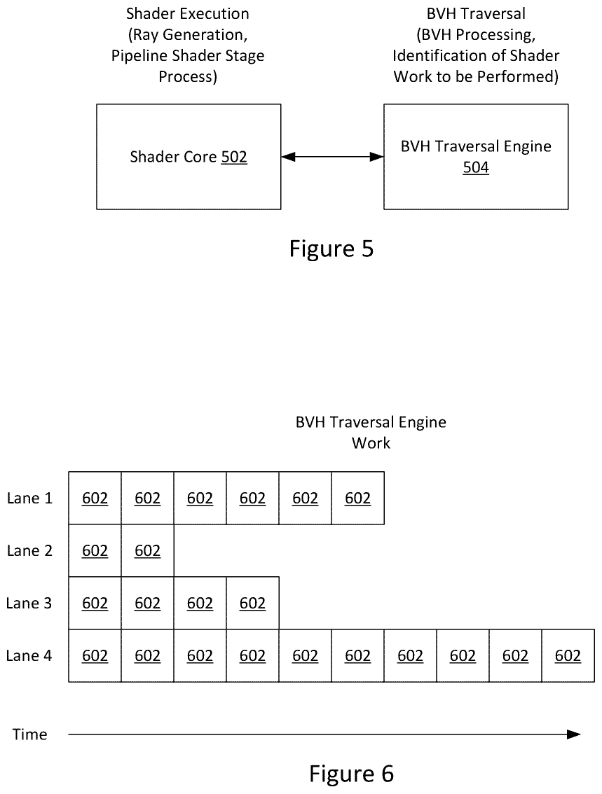

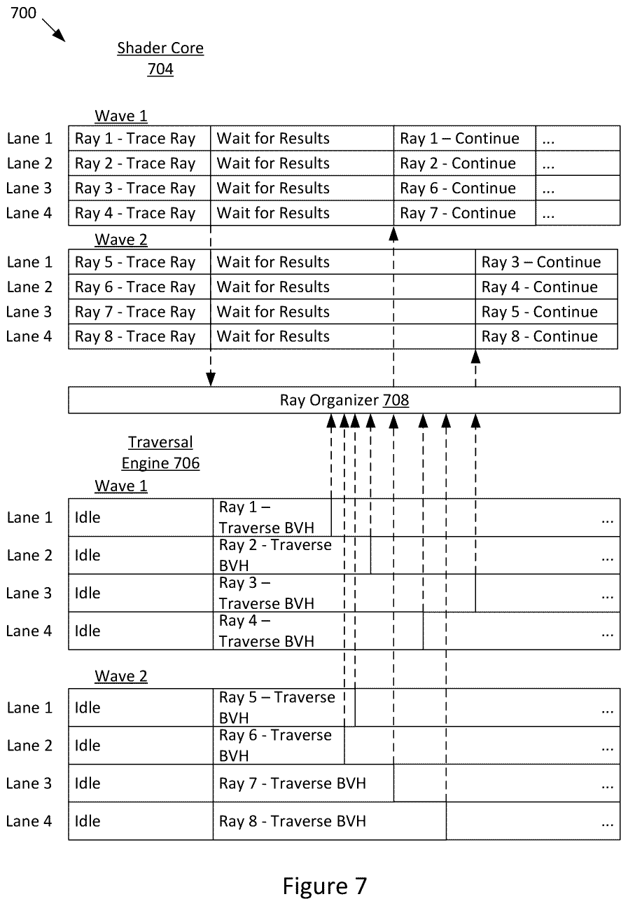

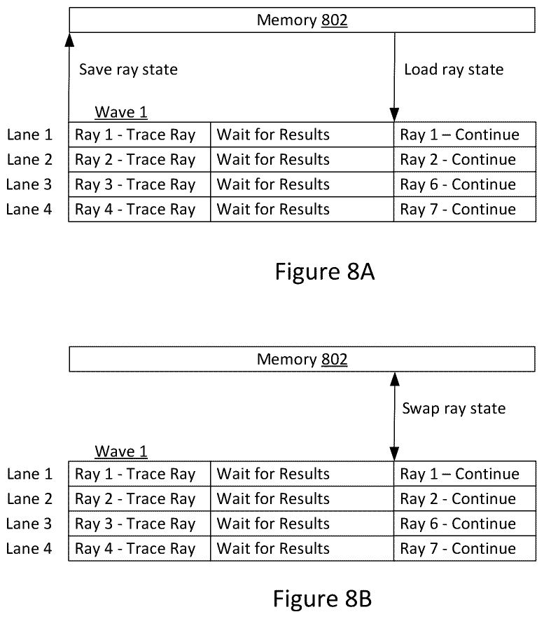

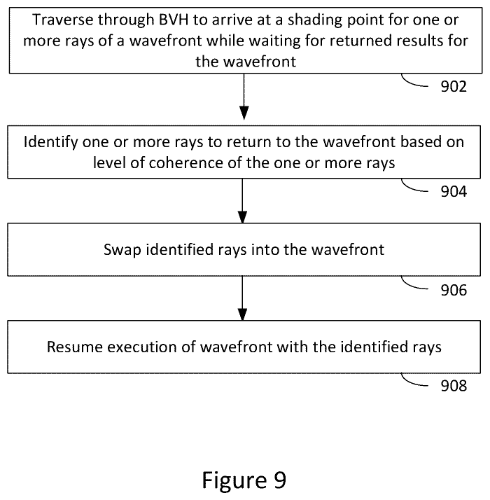

In the present disclosure, FIGS. 1-4 provide background for ray tracing. FIG. 5 illustrates a system for ray tracing. FIG. 6 illustrates divergent control flow for ray racing operations. FIG. 7 illustrates techniques for reorganizing rays between wavefronts to reduce divergence. FIGS. 8A-8B illustrate techniques for saving state for rays being swapped between wavefronts. FIG. 9 illustrates a method for swapping rays between wavefronts.

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a parallel processing paradigm, such as a single-instruction-multiple-data (“SIMD”) paradigm or a single-instruction-multiple-threads (“SIMT”). Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a parallel processing paradigm may perform the functionality described herein. Alternatively, it is contemplated that computing systems that do not perform processing tasks in accordance with a parallel processing paradigm can also perform the functionality described herein.

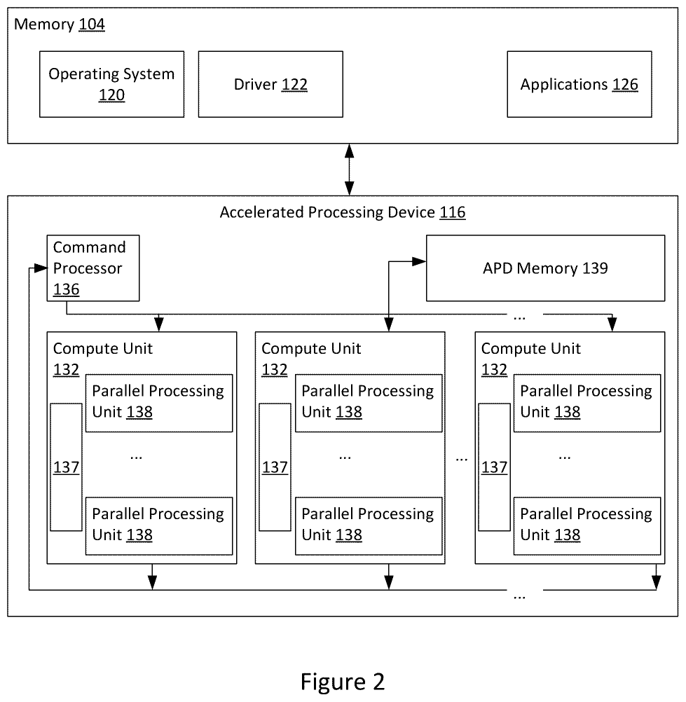

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps. One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A scheduler 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

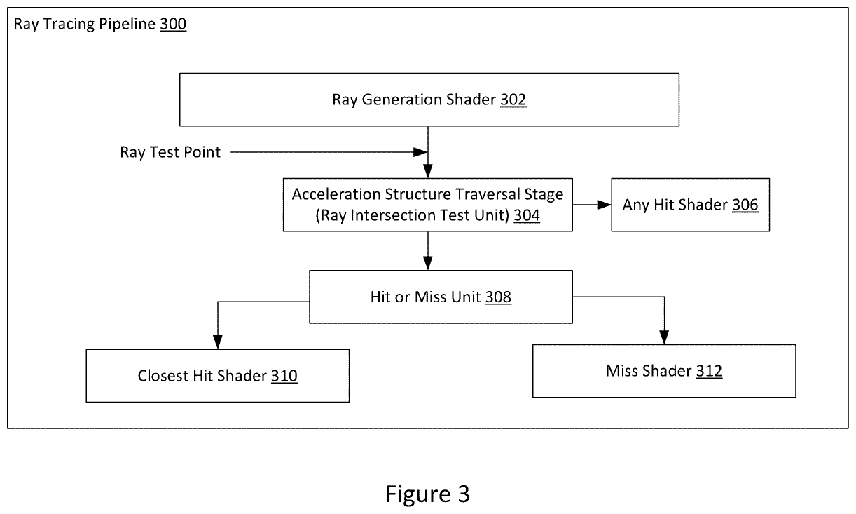

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

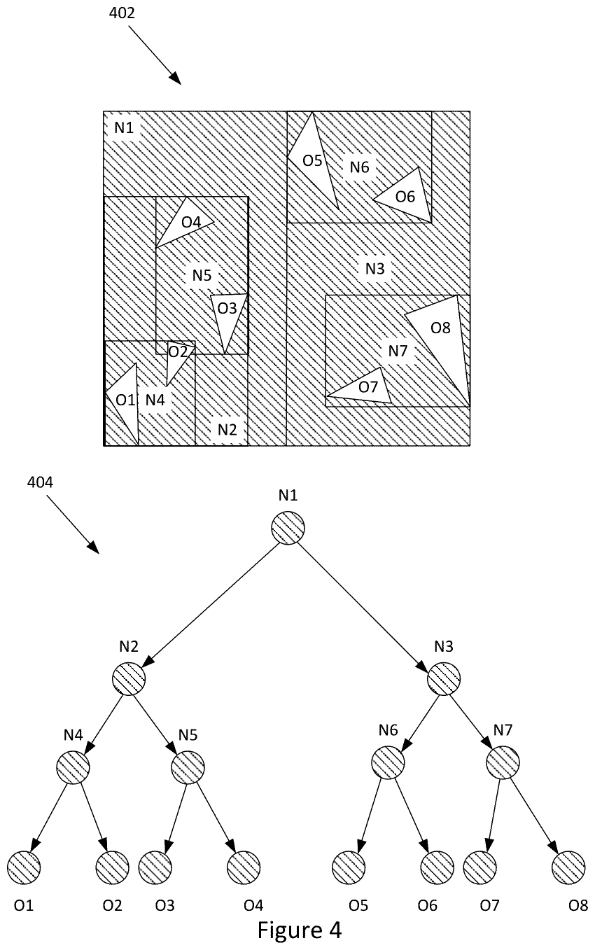

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

As can be seen, ray tracing generally involves several different types of work. Rays are generated to be cast into a scene represented by a BVH. The BVH is traversed for such rays and “shading points” are identified. These shading points represent points at which “shading work” is required. In some examples, such shading work includes execution of shader operations for an any hit shader 306, closest hit shader 310, miss shader 312, or other shader. In addition, often, rays are processed in a single instruction multiple data (“SIMD”) or single instruction multiple thread (“SIMT”) manner. In such processing, multiple rays are grouped together and execute shader code in lockstep. Areas of divergent control flow—where different rays need to execute different operations—are serialized rather than executed in parallel, with one portion executed, then another, and so on in serial fashion. Such divergent control flow and resultant serialization represents processing inefficiencies. Techniques are provided herein to help reduce divergence by reorganizing work-items across different wavefronts during execution.

FIG. 5 illustrates operation of a shader core 502 and BVH traversal engine 504 for performing ray tracing operations, according to an example. As shown, a shader core 502 communicates with a BVH traversal engine 504 to perform ray tracing operations. The shader core 502 is a programmable processor such as the SIMD unit 138 that processes instructions of a shader program in a SIMD manner. The BVH traversal engine 504 is hardware (e.g., digital circuitry) that executes commands sent by the shader core 502. In an example, the BVH traversal engine 504 is fixed function circuitry that executes operations for one or more special computer instructions (e.g., instruction set architecture instructions) that are requested by shader programs. In some examples, the BVH traversal engine 504 is referred to herein as a “traversal circuit,” and this item can be implemented in fixed function circuitry or as a processor configured to perform the operations of the BVH traversal engine 504 in any technically feasible manner (e.g., configured with device settings, with circuitry, or with software instructions that execute on one or more processors such as the APD 116). Thus the term “traversal circuit” covers both fixed function circuitry as well as a processor that is programmed with software instructions to perform the operations described herein. In particular, the shader core 502 is capable of executing an instruction requesting the BVH traversal engine 504 to traverse the BVH. Initially, this occurs for a ray specified by origin and direction with the BVH not yet being traversed at all for the ray. After the shader core 502 requests the BVH traversal engine 504 to begin, the shader core 502 executes a “wait for results” instruction that causes the shader core 502 to wait until the BVH traversal engine 504 returns results from traversing the BVH. Results typically indicate what type of shading work must be performed. Examples include executing a closest hit shader, any hit shader, miss shader, or other type of shader. Note that the BVH traversal engine 504 may request work without having completely traversed the BVH for a ray, and that after shader operations, the BVH traversal engine 504 may continue traversing the BVH for the same ray. Results returned from the BVH traversal engine 504 include information such as whether a ray intersects a triangle, the distance from the ray origin to the intersected triangle, and an indication of what type of shader (e.g., closest hit, miss, any hit) to execute. Returning results to the shader core 502 causes the shader core to again begin execution, executing whatever shader operations are necessary, and then waiting for additional results from the BVH traversal engine 504. It is also possible for the BVH traversal engine 504 to continue traversal of the BVH while the shader core 502 is performing its work. This additional traversal can be performed both for rays that have not had results returned to the shader core 502 and can also be performed speculatively for rays that have been returned. For example if a ray hits non-opaque geometry and requires an any hit shader to resolve this, the ray needs to be returned to the shader, and while that is happening the traversal engine 504 can also continue to traverse this ray to see if the traversal engine 504 finds any other intersections with geometry. If for example the traversal engine 504 finds an intersection with a piece of opaque geometry that is closer than the previously found non-opaque geometry, the outcome of the any hit shader is redundant and the new result can become the new closest hit found so far. If another non-opaque hit is found, this hit also triggers execution of the any hit shader, and either an indication of this hit buffered to be performed alter, or traversal for the ray stalls at this point until the current any hit shader (or other shader work) comes back.

FIG. 6 illustrates divergent control flow of shader execution for the shader core 502, according to an example. Time proceeds from left to right. Each box 602 represents a unit of work that takes some time to complete. Each lane is a lane of a SIMD unit 138 and is capable of executing instructions for an associated work-item. As can be seen, some lanes finish more quickly than others. In this context, the work being performed is traversal of the BVH by the BVH traversal engine 504. In this context, “finishing” means arriving at a shading point, meaning that the BVH traversal engine 504 has traversed to a part of the BVH that requires the shader core 502 to execute instructions (e.g., for a shader such as a closest hit, miss, or any hit shader). Different lanes can arrive at such a point at different times because different rays evaluated through the BVH may be determined to intersect different nodes at different times. In one example, lane 1 traverses 5 nodes before arriving at a leaf node that requires shader execution, lane 2 traverses 10 nodes, and so on. In FIG. 6, the absence of boxes 602 means that work is finished for that lane.

It could be possible to return results to the shader core 502 for subsequent execution only after every work-item in a wavefront has arrived at a shading point. However, this would mean that latency would be added to when any particular ray can be returned to the shader core 502. Thus the present disclosure provides techniques for “early return” from the BVH traversal engine 504. The early return reorganizes rays between wavefronts, selecting rays that are ready for execution, and returning these rays to lanes for execution. By searching for rays that have reached a shading point from among the rays of multiple wavefronts, it is easier to find rays that are ready to execute and thus it is possible to begin execution earlier than if such reorganization did not occur.

FIG. 7 illustrates operations for reorganizing rays among different wavefronts, according to an example. These operations are shown in a chart 700 that illustrates operations of a shader core 704 (which in various examples is similar to the shader core 502 of FIG. 5) and operations of a traversal engine 706 (which in various examples is similar to the BVH traversal engine 504 of FIG. 5), as well as operations of a ray organizer 708. In some examples, the ray organizer 708 comprises digital circuitry configured to perform the operations described herein. In the figure, time proceeds to the right from earlier points in time (on the left) to later points in time (towards the right). The graph 700 illustrates time proceeding for the shader core 704, the ray organizer 708, and the traversal engine 706. A vertical line drawn through the graph 700 corresponds to the same point in time for each of these elements.

At the earliest point in time shown (left-most point), the shader core 704 is processing the instruction to request that the traversal engine 706 performs a trace ray operation. (Prior to this point in time, the shader core 704 may perform earlier operations such as generating a ray, including a ray origin and ray direction). Operations for two wavefronts—marked “wave 1” and “wave 2”—are illustrated (note that the terms “wave” and “wavefront” has the same meaning). Wave 1 is processing ray 1 through ray 4 and wave 2 is processing ray 5 through ray 8. In this example, waves 1 and 2 are executing the trace ray instruction at the same time, but this is not necessary. It should be understood that this trace ray instruction, executed by the shader core 704 is a request from the shader core 704 to the traversal engine 706 to traverse the BVH. In some examples, this trace ray instruction or a subsequent “wait for results” instruction notifies the ray organizer 708 that wave 1 and wave 2 have executed a trace ray instruction. This acts as a notification that the rays of these waves have begun to be processed by the traversal engine 706 and that the wavefronts involved are waiting for returns from the traversal engine 706.

Subsequent to the trace ray instruction, waves 1 and 2 each wait for the results from the traversal engine 706. The ray organizer 708 tracks “waiting rays” which are the rays that are currently being processed in the traversal engine 706 or that have already been processed in the traversal engine 706 and are waiting to resume execution. At a return time, the ray organizer 708 returns one or more of the waiting rays to one or more wavefronts for subsequent execution. The ray organizer 708 is permitted to, and sometimes does, reorganize rays between wavefronts such that a ray that executed in one wavefront before becoming a waiting ray executes in a different wavefront after resuming execution. In various examples, the ray organizer 708 reorganizes such rays so that rays that are waiting can begin executing earlier than if the rays had not been reorganized. In various examples, the ray organizer 708 examines various aspects of waiting rays to determine which such waiting rays to group together for execution. In some examples, the ray organizer 708 swaps out rays from a wavefront having at least some waiting rays to include rays from a different wavefront, and causes the newly present rays to begin execution. More specifically, initially, rays in a wavefront execute a trace ray instruction and then wait for results, which cause the lanes hosting those rays to pause execution. The trace ray occurs for the rays in this wavefront. Before the BVH operations for all rays of that wavefront completes, the ray organizer 708 swaps out rays from that wavefront and puts rays from one or more other wavefronts into that wavefront, and then causes the wavefront to resume execution, with these rays from the different wavefront.

In the example of FIG. 7, two wavefronts are shown—labeled “wave 1” and “wave 2.” Wave 1 includes ray 1, ray 2, ray 3, and ray 4. Wave 2 includes ray 5, ray 6, ray 7, and ray 8. In the example shown, wave 1 and wave 2 execute the trace ray instruction at the same time and then execute wait for results. The trace ray instruction causes the traversal engine 706 to traverse the BVH for rays 1-8. The arrows from the rays up to the ray organizer 708 indicate completion times for BVH traversal for each ray. As can be seen, ray 1 completes, then ray 6 completes, then ray 5 completes, then ray 2 completes, then ray 7 completes, the ray 4 completes, then ray 8 and then ray 3. In the example shown, the ray organizer 708 decides that rays 1, 2, 6, and 7 should be assigned to wave 1 and therefore causes these rays to continue execution after traversal (in “ray X—continue”) within wave 1. As can be seen, these rays have all already completed traversal of the BVH up to a shading point and thus are available for such continuation. As can be seen, rays 6 and 7 were not already in wave 1, so the ray organizer 708 has swapped out rays 3 and 4 for rays 6 and 7. As can also be seen, if wave 1 had waited until rays 3 and 4 were available for execution, then wave 1 would have waited for longer to begin execution. Rays 3, 4, 5, and 8 begin execution in wave 2 at a later time in “ray X continue.”

As can be seen, the ray organizer 708 tracks rays that are waiting for results and, when results are available, returns such rays to a wave that is not necessarily the wave from which the ray originated. The ray organizer 708 makes decisions about when to return rays to a wavefront as well as which rays to group together. The ray organizer 708 can consider a large number of factors in making these decisions. In some examples, the ray organizer 708 considers which work must be executed at the “continue” phase for each ray. For example, if there are multiple rays that are to execute the same shader program in the “continue” phase (e.g., the same any hit shader or the same closest hit shader), then the ray organizer 708 might select such rays to group together in a wavefront. Rays that are to execute the same code in the “continue” phase are referred to as “coherent” herein. In another example, the ray organizer 708 waits until a particular number of coherent rays (e.g., a threshold number) are available before scheduling such rays together. More specifically, the ray organizer 708 waits until a number of coherent rays waiting for results is above a threshold, and, when that condition occurs, returns such rays to a wavefront in the “wait for results” phase. In some examples, the threshold is dynamically adjustable, and the ray organizer 708 sets this threshold based on one or more factors. One example includes a group completion percentage that indicates the percentage of completeness of a group containing the wavefronts. More specifically, wavefronts performing ray traversal operations are part of a group or batch that is executed together. When the batch has low completion, with few rays (e.g., 5% of the rays in the batch) having fully traversed through the BVH and rendered, it is advantageous to wait until a higher number of coherent rays are waiting for results before launching such rays together in a wavefront. However, towards the end of a batch, waiting for a high number of such rays may be detrimental, since it is relatively less likely that additional coherent rays will ever be generated. In other words, towards the end of a batch, because there is smaller number of rays still traversing through the BVH, the chance that any such ray will be coherent with other ways waiting to enter the “continue” phase is lower. Lowering the threshold number of rays allows wavefronts to resume execution, even if not fully coherent. “Fully coherent” means that all of the rays execute the same operation after returning to the wavefront. For example, if all rays in a wavefront were to execute the same any hit shader, then the wavefront would be fully coherent. If, on the other hand, some rays in a wavefront were to execute one any hit shader and other rays in the wavefront were to execute a different any hit shader or a closest hit shader, then the wavefront would not be fully coherent.

In some example, the ray organizer 708 reduces the threshold number of rays that must be coherent as a “time measure” passes (where such time measure can be measured as the time that a wavefront has been waiting for work, the time since a ray arrived at a shader point, or any other time). Thus, the longer a ray waits to be assigned to wavefront, the lower the number of coherent rays that are needed before work is assigned to a wavefront. In some examples, there is a time-out amount, as well, that indicates when the ray organizer 708 must return rays to a wave, regardless of the number of coherent rays that are available. In an example, this time out amount varies according to the group completion percentage (where a higher group completion percentage results in a lower timeout amount and a lower group completion percentage results in a higher timeout amount).

In some examples, if the time-out period elapses, then the ray organizer 708 selects rays in such a way that the wave would not be fully coherent. In an example, a wavefront can host eight rays and, when the time-out period elapses, the ray organizer 708 selects four rays that are to execute at one location in the “continue” phase and four other rays that are to execute at another location in the “continue” phase. Operations for determining when to return rays to a wave as well as how coherent such rays should be can vary in any technically feasible manner.

As stated above, the ray organizer 708 swaps rays between waves. This swapping requires a transfer of state. More specifically, each ray has certain state information that indicates information about various aspects of the ray. This is the information that allows the lane to process the ray (e.g., including information necessary for shading and/or BVH traversal, such as ray geometry (e.g., origin and direction) and other attributes. In various examples, this state information includes one or more of information for a ray about one or more hits that have been detected or information about the “call site” of a ray generation shader (e.g., the origin of the ray, that is, what shader program or other operation initially generated the ray for traversal), or other attributes used in shading.

While a lane is processing a ray, at least some of this state information for the ray is stored in registers (e.g., vector registers) for the lane. These registers are scratch space that is local to a wavefront and are not necessarily available to other wavefronts. Therefore, in order to move a ray from a first wavefront to a second wavefront, the APD 116 must transfer this state information from the local registers of the first wavefront to a location that is available to the second wavefront (such as cache or local memory, from which the second wavefront can load that information into its own registers). In some examples, the mechanism for such state transfer is that the “source wavefront” (wavefront from which at least one ray is being transferred) writes the state information into a memory that can be accessed by both the source wavefront and the “destination wavefront” (wavefront to which at least one ray is being transferred). In some examples, this memory is the LDS 137, and APD memory 139, or system memory 104. In some examples, writing the state information out to this memory also places that state information into a cache that is available to the destination wavefront. At some future point, such as when the destination wavefront needs the state information, the destination wavefront reads from the location written to by the source wavefront. Note that at the time the source wavefront writes the state information to the memory, it is not necessarily known which wavefront will be the destination wavefront (as the BVH traversal may not yet be complete for all rays from the source wavefront). Thus, in some examples, the memory into which the state information is written is accessible to all wavefronts participating in the group (e.g., the group whose completion percentage is tracked above).

It is possible to write this ray state out to the memory at different times. FIGS. 8A and 8B illustrate different configurations for writing out such state from a source wavefront, according to examples.

FIG. 8A illustrates a first operations in which a wavefront writes the ray state to the memory 802 prior to executing the wait for results instruction, according to an example. In this situation, it is not clear which rays of this wavefront will be swapped out to a different wavefront. Thus, wavefront 1 writes out the state for all rays being hosted by that wavefront (where being “hosted by the wavefront” means that the ray is processed by a lane of the wavefront). Thus even rays that are ultimately returned to the same wave (e.g., wave 1) has its state saved out to the memory 802.

In FIG. 8B, the wavefront does not write out state for the rays until the ray organizer 708 returns at least one of the at least one of the rays to a wavefront. At that time, for each ray that is being swapped from a source wavefront to a destination wavefront, the ray organizer 708 causes the source wavefront to write the data out for that ray. The ray organizer 708 also causes the destination wavefront to write out the data for rays being moved out of the destination wavefront (but not for rays remaining in the wavefront). Then, the ray organizer 708 causes the destination wavefront to read the state for the rays being swapped into the destination wavefront and the destination wavefront then begins executing. As can be seen, the delayed state save of FIG. 8B is somewhat more efficient in terms of storage space than the technique of FIG. 8A, in that state for rays not being moved from a source wavefront to a destination wavefront does not have to be saved to memory.

FIG. 9 is a flow diagram of a method 900 for performing ray tracing operations, according to an example. Although described with respect to the system of FIGS. 1-8B, those of skill in the art will understand that any system configured to perform the steps of the method 900 in any technically feasible order falls within the scope of the present disclosure.

Prior to step 902, a wavefront has executed operations in a shader core 502 and has executed a trace ray operation for a ray. At step 902, a wavefront traverses through a BVH for the trace ray operation. Such traversal involves following nodes, including non-leaf nodes until a shading point is reached. More particularly, such traversal includes arriving at a non-leaf node and checking whether the ray intersects the non-leaf node. If there is no intersection, then the traversal ignores the descendants of that node and if there is an intersection, then the traversal traverses to the descendants. A shading point occurs where there is work that is required to be performed by the shader core 502. Such work includes executing a shader program such as an any hit, closest hit, or miss shader. While this traversal is occurring, the shader core 502 is waiting for results from the BVH traversal engine 504.

At step 904, the ray organizer 708 identifies one or more rays to return to the wavefront based on a variety of factors such as the level of coherence of rays that arrived at a shading point and are waiting to be returned to a shader core 502 for execution. It should be noted that step 904 does not necessarily occur immediately after step 902, as the ray organizer 708 may wait to collect rays from one or more wavefronts. In various examples, the ray organizer 708 waits until a particular condition occurs before returning rays to the shader core 502 for execution past the shading point. In various examples, this condition includes that a time-out period has elapsed (where the time-out period is measured from the last time that rays were return to a wavefront, or from the time that the earliest ray entered the “waiting for results” period), that a threshold level of coherence exists in the rays waiting to be returned, or that a wavefront can be filled with coherent rays (e.g., a wavefront can host four rays and there are four rays that require that the same type of work, such as the same shader program, be performed).

At step 906, the ray organizer 708 swaps the waiting rays into the destination wavefront. In examples where state is written out before performing the BVH traversal for a ray, state for the rays being swapped in is available and the destination wavefront simply loads that state. In examples where state is swapped when rays are returned to wavefronts, the source wavefront and/or destination wavefront write out state (e.g., to a more global memory such as APD memory 139) for the rays that are being swapped and the destination wavefront reads the state from that memory.

At step 908, the shader core 502 resumes execution for the destination wavefront with the rays that were swapped into that destination wavefront. In general, such resumption includes executing whatever operations are necessary per the shading point (e.g., executing a shader program as specified by traversal through the BVH).

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the SIMD units 138, the ray tracing pipeline 300, including the ray generation shader 302, acceleration structure traversal stage 304, any hit shader 306, hit or miss unit 308, closest hit shader 310, miss shader 312, the shader core 502, the BVH traversal engine 504, or the ray organizer 708 may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
requesting traversal of a BVH for one or more first rays of a wavefront, wherein the requesting is transmitted by a shader core to a traversal circuit;
in response to the traversal circuit arriving at a shading point for the one or more first rays, recording that the one or more first rays are ready to be returned to the shader core;
identifying one or more second rays that are ready to be returned to the shader core, wherein the one or more second rays originate from different wavefronts; and
returning the one or more second rays to the shader core to be executed by the wavefront.

2. The method of claim 1, wherein the returning occurs in response to a time-out occurring for the one or more first rays.

3. The method of claim 2, wherein the returning occurs in response to a number of coherent rays being available for return being above a threshold.

4. The method of claim 3, wherein the threshold varies according to a completion percentage of a group of rays.

5. The method of claim 4, wherein the time-out varies according to the completion percentage.

6. The method of claim 1, further comprising saving state of the one or more first rays before the traversal circuit arrives at the shading point for the one or more first rays.

7. The method of claim 1, further comprising saving state of the one or more first rays upon returning the one or more second rays to the shader core.

8. The method of claim 1, wherein the returning causes the wavefront to execute work associated with one or more shading points.

9. The method of claim 1, wherein the identifying includes identifying rays that are coherent.

10. A system comprising:
a shader core; and
a traversal circuit,
wherein the shader core is configured to:
request traversal of a BVH for one or more first rays of a wavefront, wherein the requesting is transmitted by the shader core to the traversal circuit; and
wherein the traversal circuit is configured to:
in response to the traversal circuit arriving at a shading point for the one or more first rays, record that the one or more first rays are ready to be returned to the shader core;
identify one or more second rays that are ready to be returned to the shader core, wherein the one or more second rays originate from different wavefronts; and
return the one or more second rays to the shader core to be executed by the wavefront.

11. The system of claim 10, wherein the returning occurs in response to a time-out occurring for the one or more first rays.

12. The system of claim 11, wherein the returning occurs in response to a number of coherent rays being available for return being above a threshold.

13. The system of claim 12, wherein the threshold varies according to a completion percentage of a group of rays.

14. The system of claim 13, wherein the time-out varies according to the completion percentage.

15. The system of claim 10, wherein the shader core is further configured to save state of the one or more first rays before the traversal circuit arrives at the shading point for the one or more first rays.

16. The system of claim 10, wherein the shader core is further configured to save state of the one or more first rays upon returning the one or more second rays to the shader core.

17. The system of claim 10, wherein the returning causes the wavefront to execute work associated with one or more shading points.

18. The system of claim 10, wherein the identifying includes identifying rays that are coherent.

19. A non-transitory computer-readable medium storing instructions that, when executed by a processor, cause the processor to perform operations comprising:
requesting traversal of a BVH for one or more first rays of a wavefront, wherein the requesting is transmitted by a shader core to a traversal circuit;
in response to the traversal circuit arriving at a shading point for the one or more first rays, recording that the one or more first rays are ready to be returned to the shader core;
identifying one or more second rays that are ready to be returned to the shader core, wherein the one or more second rays originate from different wavefronts; and
returning the one or more second rays to the shader core to be executed by the wavefront.

20. The non-transitory computer-readable medium of claim 19, wherein the returning occurs in response to a time-out occurring for the one or more first rays.
